(19) United States
(12) Patent Application Publication
(10) Pub. No.: US 2015/0331927 A1
(43) Pub. Date: Nov. 19, 2015

(54) Building scalable hierarchical multi-tenant applications

(71) Applicants: RAJESH VENKATESAN, Trichy (IN); MADHAVA VENKATESH, Chennai (IN); SEZHIYAN NAVARASU, Channai (IN)

(72) Inventors: RAJESH VENKATESAN, Trichy (IN); MADHAVA VENKATESH, Chennai (IN); SEZHIYAN NAVARASU, Channai (IN)

(73) Assignee: HCL TECHNOLOGIES LTD, Noida (IN)

(21) Appl. No.: 14/706,007

(22) Filed: May 7, 2015

(30) Foreign Application Priority Data
May 15, 2014 (IN) 2409/CHE/2014

(51) Int. Cl. G06F 17/30

(52) U.S. Cl. CPC G06F 17/30584; G06F 17/30292

(57) ABSTRACT

Building scalable hierarchical multi-tenant applications. This relates to scalable, hierarchical multi-tenant applications and more particularly to abstraction of data and logic partitioning, hierarchical configuration and administration to enable developers to build scalable hierarchical multi-tenant applications. The principal object of this is to propose a method and system to enable an application to be constructed, wherein the application may support hierarchical multi-tenancy along with vertical and horizontal partitioning capabilities. Another object of the is to enable an application to be constructed, wherein the complexity of the application is abstracted as much as possible to the developers who develop the application.

### FIELD

This relates to scalable, hierarchical multi-tenant applications and more particularly to abstraction of data and logic partitioning, hierarchical configuration and administration to enable developers to build scalable hierarchical multi-tenant applications.

### BACKGROUND

Traditionally when designing applications, scalability is achieved by de-coupling functions into different services as well as partitioning data. Typically this type of partition is called a vertical partition. Once the application has been decomposed into multiple services, the next challenge is typically to scale an individual service. This is typically done by moving part of the data into a separate database based on an identifier which could be based on geographic location or based on some way to group related data together.

The problem of partitioning is particularly acute for multi-tenant applications. Multi-tenant applications typically store data of multiple customers within the same database. They also use the same instance of an application which multiple customers' access in-order to deliver services.

Hierarchical multi-tenancy may be defined as the ability to define a hierarchy of tenants and establish multi tenancy within the hierarchy. As an example if a health care service is launched by a health care service provider (dealing with retail health care products) to the entire globe, they would have the possibility of establishing a root organization, create geographies (or countries/states) as tenants within the root organization, create customers (possibly targeted hospitals which consume the service) as tenants within the geography. Every tenant in the hierarchy has access to their own data as well as data within the hierarchy.

Hierarchical multi-tenancy allows each tenant to access their own data; i.e., each tenant in the hierarchy like hospitals, geographies have access to data specific to them (which is qualified by means of a tenant identifier pointing to these tenants). Hierarchical multi-tenancy also allows access to data within the hierarchy.

The need for this kind of multi-tenancy is to launch services that span across the globe consistently with a lot of administration being handled at individual tenant level yet providing control to ancestors of the hierarchy on how the service may be consumed. This facet of hierarchical multi-tenant applications is called hierarchical configuration. Apart from the hierarchical configuration, there is need for administration of the hierarchical multi-tenant context which provides the ability to create needed hierarchy and hierarchically manage the created tenants

Currently, there is no easy way to enable an application to be constructed in a manner that it may easily support hierarchical multi-tenancy along with vertical and horizontal partitioning capabilities at the same time abstracting the complexity of the same as much as possible to the developers who develop the application.

Also, current methods do not provide any mechanism to abstract complexity of building scalable hierarchical multi-tenant applications. In most cases, the application is rewritten to support partitioning and the hierarchical configuration services or multiple instances of the same software are deployed for every tenant. Also, partitions are done from the start and typically support a separate instance per data partition as the only deployment model.

### OBJECT

The principal object of this is to propose a method and system to enable an application to be constructed, wherein the application may support hierarchical multi-tenancy along with vertical and horizontal partitioning capabilities

Another object of the is to enable an application to be constructed, wherein the complexity of the application is abstracted as much as possible to the developers who develop the application.

### STATEMENT

Accordingly the provides a method for enabling construction of an application based on data to support hierarchical multi-tenancy, the method comprising performing vertical partitioning of the data into a plurality of vertical partitions; performing horizontal partitioning of the data into a plurality of horizontal partitions; performing at least one hierarchical configuration based on the data specific to the application by a hierarchical configuration engine; and performing at least one action related to at least one tenant based on the at least one hierarchical configuration.

Also, provided herein is a system configured for enabling construction of an application based on data to support hierarchical multi-tenancy, the system configured for performing vertical partitioning of the data into a plurality of vertical partitions; performing horizontal partitioning of the data into a plurality of horizontal partitions; performing at least one hierarchical configuration based on the data specific to the application by a hierarchical configuration engine; and performing at least one action related to at least one tenant based on the at least one hierarchical configuration.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This is illustrated in the accompanying drawings, through out which like reference letters indicate corresponding parts in the various figures. The embodiments herein will be better understood from the following description with reference to the drawings, in which:

FIG. 1 is a flowchart illustrating the process of constructing an application, wherein the application may support hierarchical multi-tenancy along with vertical and horizontal partitioning capabilities and at the same time abstracting the complexity of the same as much as possible to the developers who develop the application, according to embodiments as disclosed herein;

FIG. 2 is a flowchart depicting a process of performing vertical and horizontal partitioning, according to embodiments as disclosed herein;

FIG. 3 depicts an example of two countries, Germany and France, where Germany has two hospitals and France has one hospital, according to embodiments as disclosed herein;

FIG. 4 depicts an example of a single application (service) instance to support partitioned data, according to embodiments as disclosed herein;

FIG. 5 depicts an example of a separate application (service) instance for partitioned data, according to embodiments as disclosed herein;

FIG. 6 is a flowchart illustrating the process of creating hierarchical configurations, according to embodiments as disclosed herein;

FIG. 7 is a flowchart illustrating the process of fetching hierarchical configurations, according to the embodiments as disclosed herein;

FIG. 8 illustrates the eventual deployment possibilities for the health care example wherein a single instance of the application is used while Germany and France databases are partitioned (wherein the database context is injected based on the hierarchical configuration done from the hierarchical configuration service), according to embodiments as disclosed herein; and

FIG. 9 illustrates the eventual deployment possibilities for the health care example wherein an instance per partition is shown where every country can have their own instance of the service (wherein the database context is injected based on the hierarchical configuration done from the hierarchical configuration service), according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

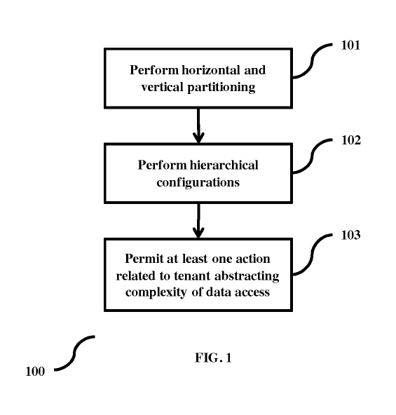

The embodiments herein disclose a method and system to enable an application to be constructed in a manner so as to support hierarchical multi-tenancy along with vertical and horizontal partitioning capabilities at the same time abstracting the complexity of the same as much as possible to the developers who develop the application. Referring now to the drawings, and more particularly to FIGS. 1 through 9, where similar reference characters denote corresponding features consistently throughout the figures, there are shown preferred embodiments.

FIG. 1 is a flowchart illustrating the process of constructing an application, wherein the application may support hierarchical multi-tenancy along with vertical and horizontal partitioning capabilities at the same time abstracting the complexity of the same as much as possible to the developers who develop the application, according to embodiments as disclosed herein. Vertical and horizontal partitioning of data is performed (101). Vertical partitioning involves partitioning of related functionality in the application under consideration leading to the creation of difference services that needs to inter-operate for various needs. In an embodiment herein, the vertical partitioning may involve more than one levels of vertical partitioning, wherein there may be sub-levels of vertical partitions. This may depend on the features which are specific to the hierarchy of the application. Horizontal partitioning comprises of cutting a portion of a data set of the application. The data set may be a new data set. The data may also be an existing data set. The process of cutting may be based on a tenant key at a pre-defined level to a pre-determined database. The tenant key may be determined by a person and/or entity with requisite permission levels to access the application. The pre-defined level may be defined by the authorized user/entity. The pre-determined database may be determined by the authorized user/entity. Further, hierarchical configurations are performed (102). For creating the hierarchical configurations, a hierarchical configuration engine is created, wherein the engine permits different tenants at different levels in the hierarchy to set configurations that are specific to the application. The configurations may be made available in an appropriate context, wherein the context depends on tenant context. At least one action related to the tenant abstracting complexity of data access is further permitted (103). The action may comprise at least one of managing creation and management of the tenants and tenant hierarchy, enabling the hierarchy to be available across all partitions (vertical and horizontal), creating a deployment archetype and so on. This may be done by providing a provisioning API (Application Programming Interface) to create tenants based on hierarchy (ability to specify parent). The API may also inform the individual partitioned application of the new addition to the hierarchy so that the hierarchy is updated accordingly. This enables creation of other additional hierarchical services within the application partition. The deployment archetype may be considered as a template, wherein the archetype comprises of specific artifacts meant for a specific purpose. The various actions in method 100 may be performed in the order presented, in a different order or simultaneously. Further, in some embodiments, some actions listed in FIG. 1 may be omitted.

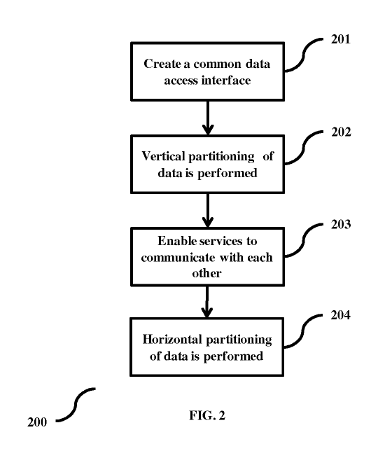

FIG. 2 is a flowchart depicting a process of performing vertical and horizontal partitioning, according to embodiments as disclosed herein. A common data access interface is created (201). The common data access interface may be created by allowing all data models to extend from a common base class and using the same base class as part of the interface contract for the common data access layer. Below is an example of the data access layer interface specification.

```
Public interface IDataAccess {
  public BaseModel create(BaseMode 1 mode1);
  public BaseModel update(BaseMode 1 mode1);
  public BaseModel delete(BaseMode 1 mode1);
  public BaseModel fetch(long id);
  public List<BaseModel>fetch(Criteria criteria);
}
```

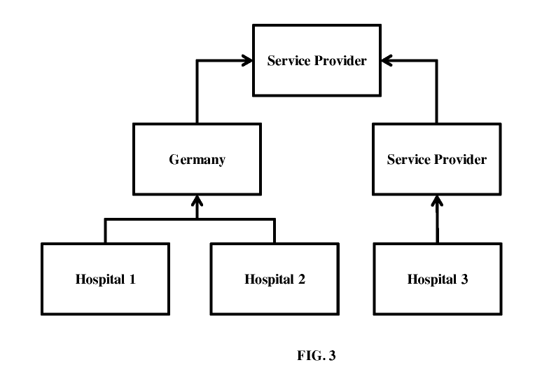

Vertical partitioning of data is performed (202), wherein vertical partitioning comprises of partitioning of related functionality in the application leading to the creation of difference services that needs to inter-operate for various needs. Consider an eCommerce portal application as a first example. A vertical partition in such an application may be an administrative and metadata portal along with the catalogue metadata tables that allows the eCommerce portal owner to configure different catalogue items that are available to be sold in the portal and an end user facing shopping cart application that displays the catalogue items and allows them to buy consisting of the user and order tables. In another example, consider Germany and France, wherein there are two hospitals Hospital 1 and Hospital 2 in Germany and one hospital (hospital 3) in France (as depicted in FIG. 3). As there is significant hospital focused functionality and the number of hospitals would be orders of magnitude greater than the geography, vertical partitioning may be done here. There may be other functionality specific to geographies for setting up the service which may be separated out and deployed separately.

A suitable means such as webservices may be used to enable (203) services to communicate with each other. This may be achieved by exposing the data access layer itself as remotely accessible such that between two services, the data managed by the service may be directly accessed using the service. In an embodiment herein, this may be achieved by exposing more functional services that does have business logic to process data. In an embodiment herein, this may be achieved by providing ability to provision the tenant hierarchy as and when it is established to the vertical service.

Considering the eCommerce example, the administrative and metadata service directly exposes Catalog table via the data access layer interface, which enables the shopping cart application to show the catalogue and also consider the order functionality. Also, assuming there has to be an inherent feature that filters out specific catalogue items based on different geographies that are not a concern of the shopping cart application, a business service needs to be written that does the actual filter of the catalogue data based on a specific context and exposes the same to the shopping cart application. Considering the health care service example, if the health care service provider has a catalogue of items that needs to be shown to hospitals for ordering, it is a potential service that may be consumed by the hospital focused service.

In an embodiment herein, there may be hierarchy specific features that may be built even within the vertical partition. This may be enabled by provisioning the tenant hierarchy into the vertical partition thereby allowing the vertical specific functionality to work. Considering the health care example, it could be possible that a bunch of hospitals are grouped together to form a hospital group adding one more level in the hierarchy. In such case the same set of services is consumed both at the hospital and hospital group level which mandates hierarchical functionality to be available even within vertical partitions.

Embodiments disclosed herein abstracts out the complexity of creating a vertical partition and enables easy creation of vertical data and logic services that interact with each other and scale seamlessly.

Horizontal partitioning is further performed (204) by horizontally cut a portion of the data set based on a tenant key at a particular level to a different database and allow the data set to be split thereby enabling a more controllable data set that is accessed and updated.

The split may involve moving an entire hierarchy out into a separate database. Considering the health care example, there may be a need to move out data specific to Germany alone into a different database. This can happen because of performance and scale reasons or even for compliance reasons. Abstraction of the horizontal partitioning may be performed using the common data access interface. When a query is being made, the context of the query can be injected external to the user that allows the data access layer to decide to which database the query is targeted. In an embodiment herein, the tenant identifier may be the key based on which the horizontal partitioning may be established, the tenant identifier of the current logged in user may be injected into the context of execution so that the data access layer may understand which database the query is targeted towards. In a programming language such as java/j2ee, the concept of a datasource configured at the container may be injected into the context of the Java Persistence API EntityManager based on the current context. The data source may be configured at any point in time. As long as the data access layer depends on the “context” to come in externally, the data access layer may be pointed to query from an appropriate database. In this case of an entire hierarchy being moved, the hierarchical configuration service may be used to define a data source at the level in hierarchy at which the partition has been established. Because of the behavior of the hierarchical service all tenants which are descendants of the partitioned tenant automatically default to the parent data source definition. The various actions in method 200 may be performed in the order presented, in a different order or simultaneously. Further, in some embodiments, some actions listed in FIG. 2 may be omitted.

Embodiments herein discloses enables seamless partition of data at a stage not necessarily known during the development of the software but can be decided at runtime.

Embodiments disclosed herein enable an administrator to use a single database for the service and as data grows, the administrator may define a different data source for a specific subset of users based on tenant identifier and then allows this context to be passed on to the data access layer to decide which data source to use for which user request at runtime. Passing a context may be made generic if the data access layer externalizes the concern to a generic metadata service for determining the right data source by passing the current context available to it.

The above mentioned method for partitioning of data may be performed on existing data or new data. In an example, as a policy the eCommerce portal may decide that all geographies will get its own database and therefore whenever a new geography is launched, a new data source is configured and injected within the application at runtime.

In an embodiment herein, data may be manually partitioned and a new data source configured manually.

In the example of the health care provider example, each geography may get its own database. So, Hospital 1 and Hospital 2 would be in a separate database and Hospital 3 would be in a separate database.

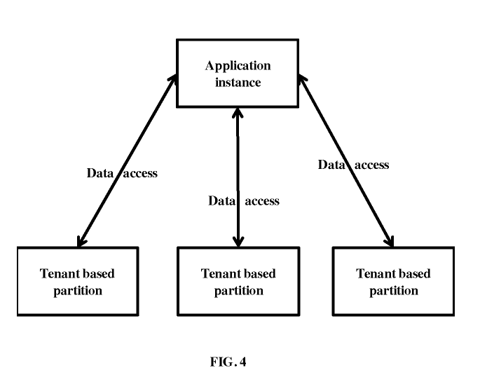

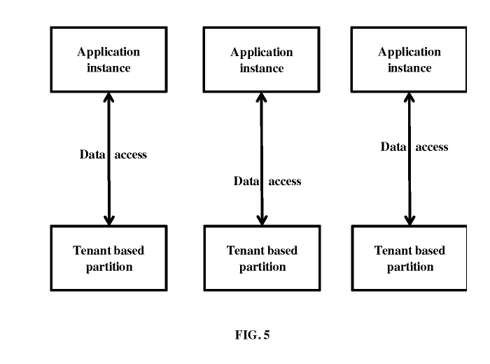

Embodiments disclosed herein allow a single application (service) instance to support partitioned data, wherein the partitioned data may be partitioned based on the tenant (as shown in FIG. 4). Embodiments disclosed herein also enable the possibility of having a separate application (service) instance for partitioned data, wherein the partitioned data may be partitioned based on the tenant (as depicted in FIG. 5).

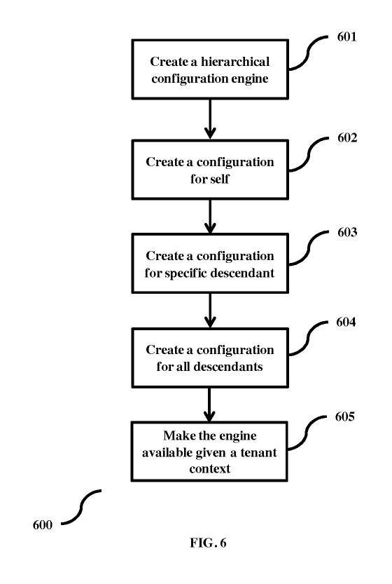

FIG. 6 is a flowchart illustrating the process of creating hierarchical configurations, according to embodiments as disclosed herein. A hierarchical configuration engine is created (601). The hierarchical configuration engine may be used to allow different tenants at different levels in the hierarchy to set configurations that are specific to the application. The hierarchical configuration engine may follow a specific set of rules. A tenant at any level in the hierarchy defines (602) configurations applicable for self. A tenant at any level in the hierarchy defines (603) configurations applicable for all their descendants. A tenant at any level in the hierarchy defines (604) configurations applicable for a specific descendant. On completing the configuration, the hierarchical configuration engine may be made available (605) appropriately given a tenant context. The various actions in method 600 may be performed in the order presented, in a different order or simultaneously. Further, in some embodiments, some actions listed in FIG. 6 may be omitted.

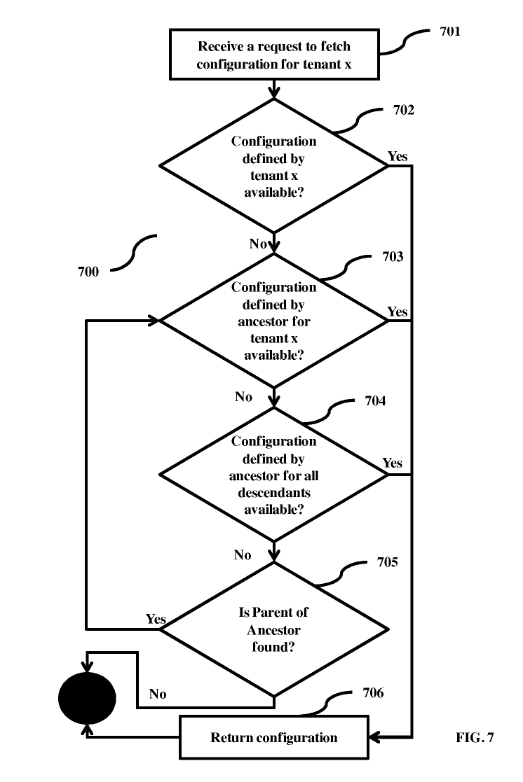

FIG. 7 is a flowchart illustrating the process of fetching hierarchical configurations, according to the embodiments as disclosed herein. Consider receiving (701) a request to fetch configuration for tenant x. A first check is made (702) if a configuration defined by tenant x for itself is available. If the configuration defined by tenant x is available, the configuration is returned (706). If the configuration defined by tenant x is not available, a further check is made (703) if a configuration defined by an ancestor for tenant x is available. If the configuration defined by an ancestor for tenant x is available, the configuration is returned (706). If the configuration defined by an ancestor for tenant x is not available, a further check is made (704) if a configuration defined by an ancestor for all descendants is available. If the configuration defined by an ancestor for all descendants is available, the configuration is returned (706). If the configuration defined by an ancestor for all descendants is not available, a further check is made (705) for at least one parent of an ancestor. If at least one parent of an ancestor was found, the steps 703-704 are repeated. If at least one parent of an ancestor is not found, the process goes into the initial state, till a new request for fetching configuration is received. On returning the configuration, the process goes into the initial state, till a new request for fetching configuration is received. For example, when Hospital 1 in the Health Care Service example requests for a configuration with respect to the total number of shifts nurses work at the hospital, the configuration services returns the configuration defined by the hospital if available, the configuration defined by immediate parent (Germany) specifically for Hospital 1 if available, the configuration defined by immediate parent (Germany) for all of the parents children if available (wherein the last two steps may be iterative until the root node is reached. i.e. if Germany has not done any configuration it loops until it reaches the root node). The various actions in method 700 may be performed in the order presented, in a different order or simultaneously. Further, in some embodiments, some actions listed in FIG. 7 may be omitted.

Embodiments herein enable the creation and management of the tenants and tenant hierarchy and enable the hierarchy to be available across all partitions. A provisioning API is provided, wherein the provisioning API enables creation of tenants based on hierarchy (ability to specify parent). The provisioning API also informs the individual partitioned application of new additions to the hierarchy so that the hierarchy is updated accordingly. This enables creation of other additional hierarchical services within the application partition itself.

In a standard programming environment (such as Java/J2EE), embodiments enable deployment of an archetype that packages all of the above and enables abstraction of the partition complexity. An archetype may be considered as a template that consists of specific artifacts meant for a specific purpose. The deployment archetype may comprise of a base web archive and a Hierarchical Configuration and Administration web archive. The base web archive further comprises of the source of the base data model class which every other data model will extend, the interface definition of the data access layer, an implementation class of the data access layer, a filter which helps set the context of the current request based on various parameters passed in as part of the request, implementation for exposing the data access layer as a webservice, all required libraries needed for the above functions and a provisioning API implementation that creates the tenant hierarchy whenever a tenant gets added. The Hierarchical Configuration and Administration web archive allows hierarchical configuration of different settings within the application, provisions tenants (which internally provisions the hierarchy across all running instances of the services) and manage tenants.

Embodiments disclosed herein may be extended to other programming languages based on the way packaging is done within the languages.

By allowing the use of an archetype, the complexity of partition is easily abstracted and enables the developer to concentrate of the actual business functionality.

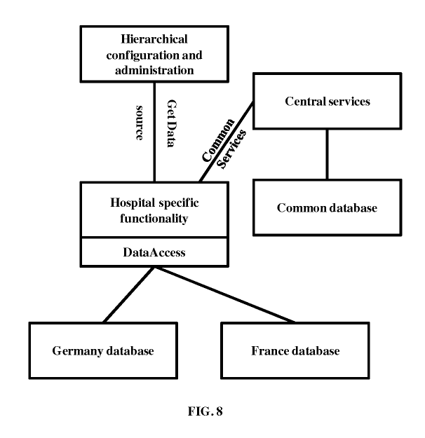

FIG. 8 illustrates the eventual deployment possibilities for the health care example wherein a single instance of the application is used while Germany and France databases are partitioned, according to embodiments as disclosed herein. Here, the database context is injected based on the hierarchical configuration done from the hierarchical configuration service.

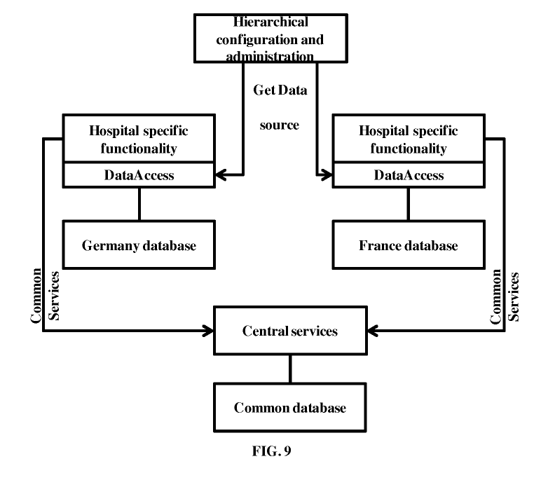

FIG. 9 illustrates the eventual deployment possibilities for the health care example wherein an instance per partition is shown where every country can have their own instance of the service, according to embodiments as disclosed herein. Here, the database context is injected based on the hierarchical configuration done from the hierarchical configuration service.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for enabling construction of an application based on data to support hierarchical multi-tenancy, the method comprising
performing vertical partitioning of the data into a plurality of vertical partitions;
performing horizontal partitioning of the data into a plurality of horizontal partitions;
performing at least one hierarchical configuration based on the data specific to the application by a hierarchical configuration engine; and
performing at least one action related to at least one tenant based on the at least one hierarchical configuration.

2. The method, as claimed in claim 1, wherein the method further comprises of creating a common data access interface;
performing vertical partitioning of the data into the plurality of vertical partitions;
enabling at least one service to communicate across the plurality of vertical partitions; and
performing horizontal partitioning of the data into the plurality of horizontal partitions.

3. The method, as claimed in claim 2, wherein performing vertical partitioning of the data comprises of performing partitioning of related functionality in the application.

4. The method, as claimed in claim 2, wherein enabling at least one service to communicate across the vertical partitions comprises of performing at least one of
exposing a data access layer as remotely accessible;
exposing at least one functional service that comprises of business logic to process data; and
provisioning a tenant hierarchy as and when it is established to the plurality of vertical partitions.

5. The method, as claimed in claim 2, wherein performing horizontal partitioning of the data comprises of cutting a portion of a data set of the application.

6. The method, as claimed in claim 4, wherein performing horizontal partitioning of the data is based on a tenant key.

7. The method, as claimed in claim 1, wherein performing at least one hierarchical configuration based on the data specific to the application by the hierarchical configuration engine comprises of
configuring at least one rule by at least one tenant; and
making the configuration available based on a tenant context.

8. The method, as claimed in claim 7, wherein the rule comprises of at least one of
configurations applicable for the tenant;
configurations applicable for all descendants of the tenant; and
configurations applicable for a descendant of the tenant.

9. The method, as claimed in claim 1, wherein the at least one action comprises of at least one of
creating a tenant;
managing a tenant;
creating a tenant hierarchy;
managing a tenant hierarchy; and
creating a deployment archetype.

10. The method, as claimed in claim 9, wherein managing the tenant hierarchy comprises of enabling the tenant hierarchy to be available across the plurality of vertical partitions and the plurality of horizontal applications.

11. A system configured for enabling construction of an application based on data to support hierarchical multi-tenancy, the system configured for
performing vertical partitioning of the data into a plurality of vertical partitions;
performing horizontal partitioning of the data into a plurality of horizontal partitions;
performing at least one hierarchical configuration based on the data specific to the application by a hierarchical configuration engine; and
performing at least one action related to at least one tenant based on the at least one hierarchical configuration.

12. The system, as claimed in claim 11, wherein the system is further configured for
creating a common data access interface;
performing vertical partitioning of the data into the plurality of vertical partitions;
enabling at least one service to communicate across the plurality of vertical partitions; and
performing horizontal partitioning of the data into the plurality of horizontal partitions.

13. The system, as claimed in claim 12, wherein the system is further configured for performing vertical partitioning of the data by performing partitioning of related functionality in the application.

14. The system, as claimed in claim 12, wherein the system is further configured for enabling at least one service to communicate across the vertical partitions by performing at least one of
exposing a data access layer as remotely accessible;
exposing at least one functional service that comprises of business logic to process data; and
provisioning a tenant hierarchy as and when it is established to the plurality of vertical partitions.

15. The system, as claimed in claim 12, wherein the system is further configured for performing horizontal partitioning of the data by cutting a portion of a data set of the application.

16. The system, as claimed in claim 15, wherein the system is further configured for performing horizontal partitioning of the data based on a tenant key.

17. The system, as claimed in claim 11, wherein the system is further configured for performing at least one hierarchical configuration based on the data specific to the application by the hierarchical configuration engine by
configuring at least one rule by at least one tenant; and
making the configuration available based on a tenant context.

18. The system, as claimed in claim 17, wherein the rule comprises of at least one of
configurations applicable for the tenant;
configurations applicable for all descendants of the tenant; and
configurations applicable for a descendant of the tenant.

19. The system, as claimed in claim 11, wherein the at least one action comprises of at least one of
creating a tenant;
managing a tenant;
creating a tenant hierarchy;
managing a tenant hierarchy; and
creating a deployment archetype.

20. The system, as claimed in claim 11, wherein the system is further configured for managing the tenant hierarchy by enabling the tenant hierarchy to be available across the plurality of vertical partitions and the plurality of horizontal applications.
